(19) United States
(12) Patent Application Publication
(10) Pub. No.: US 2016/0079618 A1
(43) Pub. Date: Mar. 17, 2016

(54) FUEL BATTERY SYSTEM

(71) Applicant: SUZUKI MOTOR CORPORATION, Shizuoka (JP)

(72) Inventors: Akihiro FUKUNAGA, Shizuoka (JP); Kazuyuki HIROTA, Shizuoka (JP); Toru EGUCHI, Shizuoka (JP); Shinichiro TAKADA, Shizuoka (JP)

(73) Assignee: SUZUKI MOTOR CORPORATION, Shizuoka (JP)

(21) Appl. No.: 14/854,112

(22) Filed: Sep. 15, 2015

(30) Foreign Application Priority Data
Sep. 16, 2014 (JP) 2014-187359

(51) Int. Cl. H01M 8/04

(52) U.S. Cl. CPC H01M 8/04223; H01M 8/04201; H01M 8/0438; H01M 2250/20

(57) ABSTRACT

There are provided a hydrogen tank for compressed storage of hydrogen gas, as fuel gas, at high pressures; a fuel cell stack for generating and supplying power using the hydrogen gas from the hydrogen tank; a hydrogen supply path interconnecting the hydrogen tank and the fuel cell stack; a shutoff valve for allowing supply of the hydrogen gas from the hydrogen tank by opening or closing the hydrogen supply path; a fuel supply valve, situated downstream of the shutoff valve, with respect to a supply direction of oxygen gas, for allowing supply of hydrogen gas to fuel cell stack; and an ECU for controllably causing the fuel supply valve to assume its closed state and the shutoff valve to assume its opened state during filling the hydrogen tank with hydrogen gas.

### CROSS-REFERENCE

This document claims priority to Japanese Patent Application Number 2014-187359, filed Sep. 16, 2014, the entire content of which is hereby incorporated by reference.

### TECHNICAL FIELD

The present invention relates to fuel cell systems for mitigating a pressure increase of fuel gas to be supplied to fuel cells.

### BACKGROUND ART

In a motor vehicle having a fuel cell stack using hydrogen gas as fuel, hydrogen gas is stored, as fuel, within a fuel tank that is a vessel fixedly mounted to a motor vehicle in a high pressure state at pressures not exceeding the maximum safe pressure of 70 [MPa]. The fuel tank and a negative electrode side of the fuel cell stack are interconnected by a hydrogen supply path that is provided for supply of hydrogen gas to the fuel cell stack. The hydrogen supply path is provided with a main shutoff valve configured to control allowing or blocking supply of hydrogen gas by fully opening or closing the hydrogen supply path.

In such fuel cell system, it is important to prevent excessive pressure rise of hydrogen gas to be supplied to the fuel cell stack if there is the possibility of supplying an extremely high pressure to the fuel cell stack upon supply of hydrogen gas to the fuel cell stack owing to the high pressure state within the fuel tank. This is because it is just as likely that the fuel cell stack may be damaged if extremely pressurized hydrogen gas is supplied to the fuel cell stack.

As one of measures that can be taken against the above-mentioned problem, it is proposed by JP2006-236799A, called Patent Literature 1 below, to provide a pressure sensor in a hydrogen supply path and stop supply of hydrogen gas by closing a shutoff valve when a pressure indicated by the pressure sensor exceeds a predetermined value.

As amount of hydrogen gas stored in the fuel tank decreases owing to consumption of hydrogen gas by fuel cell stack, pressure inside the fuel tank also reduces. Upon or immediately after the pressure inside the fuel tank becoming, for example, 10 [MPa] as caused by consumption of hydrogen gas, the fuel cell system is stopped, the main shutoff valve is closed, and pressure downstream of the main shutoff valve, with respect to a supply-direction, i.e., a direction in which hydrogen gas is supplied from the main shutoff valve, reduces below 10 [MPa]. If, in this state, the fuel tank is filled with hydrogen gas and the pressure inside the fuel tank is returned to 70 [MPa], pressure upstream of the main shutoff valve, with respect to the supply direction, becomes very high as compared to pressure downstream of the main shutoff valve. If, during this time, the fuel cell system is started and the main shutoff valve is opened, there is an instantaneous input of hydrogen gas at pressure of 70 [MPa] downstream of the main shutoff valve, causing appearance of inrush pressure as high as or higher than 80 [MPa] downstream of the main shutoff valve.

### PRIOR ART

### Patent Literature

Patent Literature 1: JP2006-236799A

### SUMMARY OF INVENTION

### Technical Problem

Since such inrush pressure is instantaneous pressure buildup, the fuel cell system described in JP2006-236799A, however, cannot block the appearance of inrush pressure because closing the main shutoff valve upon pressure detection by the pressure sensor would be too late to block such instantaneous pressure buildup.

Accordingly, an object of the present invention is to provide a fuel cell system capable of preventing deterioration in durability of fuel cell stack by restraining appearance of excessive pressure after filling a fuel tank with a fuel gas.

### Solution to Problem

According to one aspect of the present invention to solve the above-mentioned problem, a fuel cell system comprises: a fuel tank configured to store fuel gas; a fuel cell stack configured to generate and supply power using the fuel gas from the fuel tank; a fuel supply path interconnecting the fuel tank and the fuel cell stack; a shutoff valve configured to allow supply of the fuel gas from the fuel tank by opening or closing the fuel supply path; a fuel supply valve, situated downstream of the shutoff valve, with respect to a supply direction of the fuel gas, configured to allow supply of the fuel gas to the fuel cell stack; and a controller configured to control the shutoff valve and the fuel supply valve to control supply of the fuel gas from the fuel tank, the controller causing the fuel supply valve to assume its closed state and the shutoff valve to assume its opened state during filling the fuel tank with the fuel gas.

### Advantageous Effects of Invention

The present invention enables prevention of deterioration in durability of the fuel cell stack by restraining the appearance of excessive pressure after filling the fuel tank with the fuel gas.

### BRIEF DESCRIPTION OF DRAWINGS

FIG. 1 is a schematic block diagram of an embodiment of a fuel cell system according to the present invention.

FIG. 2 is timing diagrams illustrating pressure variations downstream of a shutoff valve, with respect to a supply direction, from hydrogen filling of the embodiment of fuel cell system according to the present invention to start-up of the fuel cell system.

### DESCRIPTION OF EMBODIMENTS

Referring to the accompanying drawings, the description according to the present invention is described below.

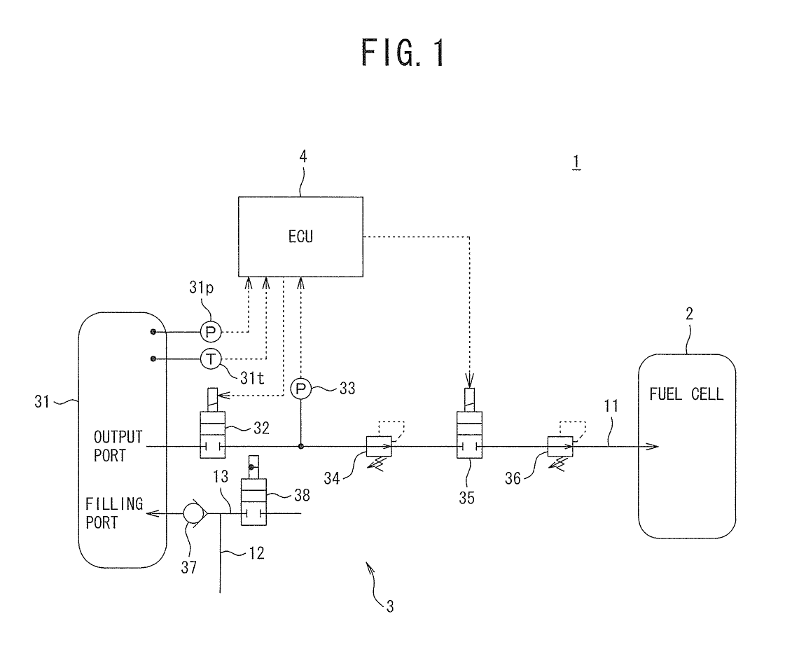

In FIG. 1, a motor vehicle 1 installed with the embodiment of fuel cell system according to the present invention includes a fuel cell stack 2, a fuel supply system 3, and an ECU (Electronic Control Unit) 4 as a controller.

Fuel cell stack 2 includes fuel cells, each being a device that generates electricity by electrochemical reactions between fuel gas, such as, hydrogen gas supplied from fuel supply system 3 and oxygen agent gas containing oxygen via an electrolyte and allows energy from being directly drawn from electrodes disposed across the electrolyte.

Fuel supply system 3 includes a hydrogen tank 31, as a fuel tank, a shutoff valve 32, a pressure sensor 33, a primary regulator 34, a fuel supply valve 35, a secondary regulator 36, a check valve 37, and a pressure relief valve 38.

Hydrogen tank 31 is a tank for compressed storage of hydrogen ay high pressure. There are provided on hydrogen tank 31 a tank pressure sensor 31p for detection of pressure of hydrogen gas stored in hydrogen tank 31 and a tank temperature sensor 31t for detection of temperature within hydrogen tank 31.

Hydrogen tank 31 and fuel cell stack 2 are interconnected by a fuel supply path 11. There are provided on fuel supply path 11 shutoff valve 32, pressure sensor 33, primary regulator 34, fuel supply valve 35, and secondary regulator 36 in this order from the upstream side, with respect to a supply direction in which hydrogen gas is supplied from hydrogen tank 31 to fuel cell stack 2. Thus, fuel supply path 11 constitutes a fuel supply path used in the present invention. In addition, there is connected to hydrogen tank 31 a hydrogen filling pipe 12 for filling hydrogen tank 31 with hydrogen gas.

Shutoff valve 32 is made of a normally closed type solenoid valve whose open/close is controlled by ECU 4. If this shutoff valve 32 is in a valve closed state, the inside of hydrogen tank 31 is made to be in a tightly closed state. Pressure sensor 33 detects pressure downstream of shutoff valve 32 with respect to the supply direction. Primary regulator 34 reduces pressure of hydrogen gas supplied from hydrogen tank 31 to a pressure less than 1.0 [MPa].

Fuel supply valve 32 is made of a normally closed type solenoid valve whose open/close is controlled by ECU 4. If shutoff valve 32 and fuel supply valve 35 are in their valve opened states, hydrogen gas within hydrogen tank 31 is supplied through hydrogen supply path 11 to fuel cell stack 2. On the other hand, if fuel supply valve 35 is made to be in the valve closed state, hydrogen gas will not be supplied to fuel cell stack 2. Secondary regulator 36 further reduces hydrogen gas that has been reduced by primary regulator 34 to a target pressure that is a pressure at which hydrogen gas is to be supplied to fuel cell stack 2.

There is provided on hydrogen filling pipe 12 a check valve 37. Check valve 37 is a valve that prevents hydrogen gas from reversing in a direction opposite to a filling direction in which hydrogen gas is filled. Pressure relief pipe 13 is connected to pressure filling pipe 12 at a portion upstream of check valve 37 with respect to the filling direction. Pressure relief valve 38 is provided on pressure relief pipe 13. Pressure relief valve 38 is provided to automatically reduce pressure when internal pressure in hydrogen filling pipe 12 abnormally increases.

A filling receptacle, not shown, is connected to an end of hydrogen filling pipe 12 opposite to the end at which hydrogen filling pipe 12 is connected to hydrogen tank 31. The filling receptacle is connected to a filling nozzle of a hydrogen station, not shown, upon filling hydrogen tank 31 with hydrogen gas. Hydrogen gas supplied from the hydrogen station runs through hydrogen filling pipe 12 upon filling hydrogen tank 31.

ECU 4 is made of a computer unit that includes a CPU (Central Processing Unit), a RAM (Random Access Memory), a ROM (Read Only Memory), input ports and output ports.

ROM of ECU 4 stores programs for making the computer unit serve as ECU 4 as well as various control-parameters and various kinds of maps. In other words, in ECU 4, the computer unit serves as ECU 4 by executing the stored programs by CPU.

There are connected to input ports of ECU 4 various kinds of sensors or the like including the before-described pressure sensor 31p, tank temperature sensor 31t and pressure sensor 33. On the other hand, there are connected to output ports of ECU 4 various kinds of control objects including shutoff valve 32 and fuel supply valve 35.

ECU 4 is able to close shutoff valve 32 if pressure detected by pressure sensor 33 exceeds a predetermined upper limit pressure, where the upper limit pressure is a pressure value that will not damage the side downstream of shutoff valve 32 with respect to the supply direction, experimentally determined and stored in ROM of ECU 4.

ECU 4 is able to shift the control state of motor vehicle 1 to a filling state upon detecting that the filling nozzle of the hydrogen station is coupled to the before-mentioned filling receptacle in a state where, for example, the fuel cell system is suspended.

ECU 4 is able to open shutoff valve 32 after shifting the control state of the motor vehicle to the filling state. During this time, ECU 4 keeps fuel supply valve 35 closed. Subsequently, ECU 4 closes shutoff valve 32 when the filling nozzle is disengaged from the filling receptacle upon completion of hydrogen filling.

Subsequently, upon start-up of fuel cell system, ECU 4 opens shutoff valve 32, and controls on/off of fuel supply valve 35 to supply hydrogen gas to fuel cell stack 2, causing fuel cell stack 2 to generate electricity.

It follows from this that an inrush pressure that is an excessively high pressure will not appear at a portion downstream of shutoff valve 32 with respect to the supply direction upon or after start-up of the fuel cell system because hydrogen gas is kept supplied to the portion downstream of the shutoff valve 32 by opening shutoff valve 32 during filling hydrogen tank 31 with hydrogen gas and there appears no difference in pressure between upstream side and downstream side of shutoff valve 32 with respect to the supply direction.

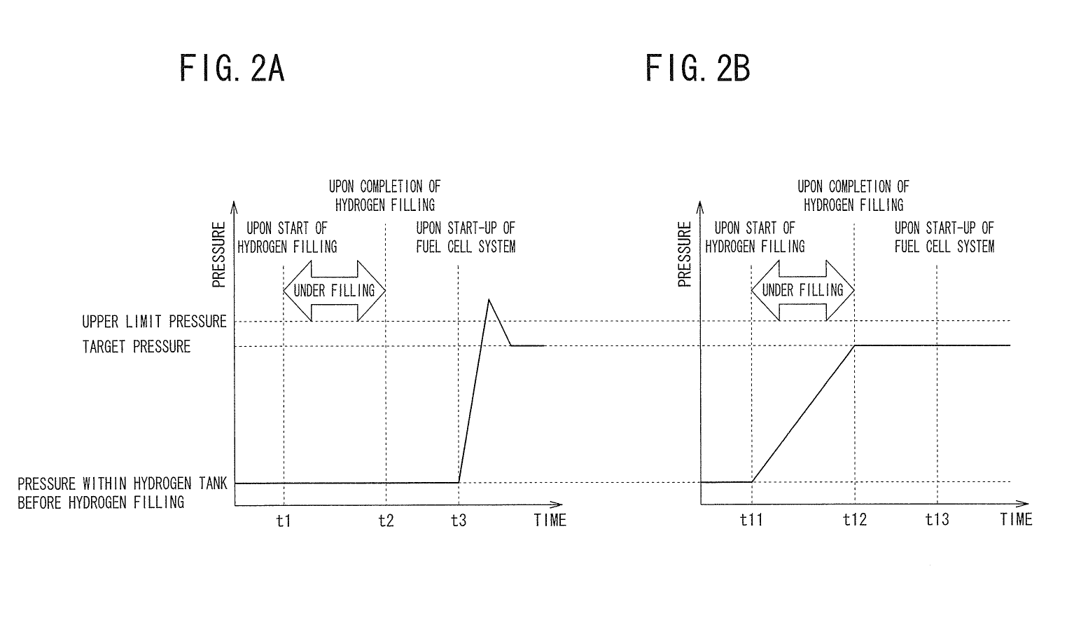

Referring to FIG. 2, it is described how the embodiment of fuel cell system, described above, works.

FIG. 2(A) is a timing diagram illustrating pressure variation downstream of a shutoff valve 32, with respect to a supply direction, from hydrogen filling by a conventional fuel cell system to start-up of the fuel cell system. As shown in FIG. 2(A), the pressure at a portion downstream of shutoff valve 32 with respect to the supply direction becomes less than a pressure within hydrogen tank 31 immediately before suspension of fuel cell system because shutoff valve 32 is closed upon suspension of fuel cell system.

At the moment t1, the pressure remains invariable even upon start of hydrogen filling, and the pressure remains invariable at the moment t2 even upon completion of hydrogen filling after pressure within hydrogen tank 31 has reached a target pressure set for hydrogen filling. At this moment, the pressure at port upstream of shutoff valve 32 with respect to the supply direction has become extremely greater than the pressure at portion downstream of shutoff valve 32 with respect to the supply direction. Shutoff valve 32 remains closed even after completion of hydrogen filling.

Thus, when shutoff valve 32 is opened at the moment t3 upon start-up of fuel cell system, hydrogen gas at high pressure instantaneously flows into the portion downstream of shutoff valve 32 with respect to the supply direction and inrush pressure that is excessively high pressure appears. During this time, when the pressure exceeds the before-described upper limit pressure, shutoff valve 32 is closed upon detection of abnormal pressure.

FIG. 2(B) is a timing diagram illustrating pressure variation downstream of a shutoff valve 32, with respect to a supply direction, from hydrogen filling by the fuel cell system according to the embodiment to start-up of the fuel cell system. As shown in FIG. 2(B), as with the conventional system, the pressure at a portion downstream of shutoff valve 32 with respect to the supply direction becomes less than a pressure within hydrogen tank 31 immediately before suspension of fuel cell system because shutoff valve 32 is closed upon suspension of fuel cell system.

At the moment t11, since shutoff valve 32 is opened upon start of hydrogen filling, the pressure at portion downstream of shutoff valve 32 increases as the pressure within hydrogen tank 31 increases owing to hydrogen filling to hydrogen tank 31.

At the moment t12 upon completion of hydrogen filling after pressure within hydrogen tank 31 has reached the target pressure upon hydrogen filling, the pressure at the portion downstream of shutoff valve 32 with respect to the supply direction becomes the target pressure. Shutoff valve 32 is closed upon completion of hydrogen gas filling.

Thus, when shutoff valve 32 is opened at the moment t13 upon start-up of fuel cell system, hydrogen gas at high pressure will not flow into the portion downstream of shutoff valve 32 with respect to the supply direction because the pressure at the portion upstream and the pressure at the portion downstream of shutoff valve 32 with respect to the supply direction are generally the same, and excessively high pressure will not appear. This avoids the occurrence of the before-described event that the upper limit pressure is exceeded.

Technical effects of the described embodiment of fuel cell system are described.

The above-described embodiment includes ECU 4 that is able to controllably put shutoff valve 32 in the opened state in addition to putting fuel supply valve 35 in the closed state during hydrogen gas filling to oxygen tank 31.

This can eliminate a pressure difference between the pressure upstream and pressure downstream shutoff valve 32, with respect to the supply direction, during hydrogen filling, mitigate appearance of excessively high pressure downstream of shutoff valve 32 with respect to the supply direction upon start-up of fuel cell system, and prevent deterioration of durability of fuel cell stack 2.

Moreover, ECU 4 controllably shifts shutoff valve 32 from the opened state to the closed state upon or after completion of hydrogen gas filling to hydrogen tank 31.

This can prevent outflow of hydrogen gas to the portion downstream of shutoff valve 32 with respect to the supply direction because shutoff valve 32 is closed upon or after completion of hydrogen gas filling to hydrogen tank 31, and thus prevent deterioration of durability of fuel cell stack 2.

Moreover, since pressure sensor 33 is provided between shutoff valve 32 and fuel supply valve 35, ECU 4 is able to controllably put shutoff valve 32 into the closed state if the pressure detected by pressure sensor 33 exceeds the upper limit pressure.

This can suspend supply of hydrogen gas if excessively high pressure greater than the upper limit pressure appears between shutoff valve 32 and fuel supply valve 35, thus preventing deterioration of durability of fuel cell stack 2.

Although the embodiment of the present invention has been described, it will be apparent to person skilled in the art that modifications may be made without departing from the scope of the present invention. All such modifications and equivalents thereof are intended to be covered by the following claims described in scope of claims.

### DESCRIPTION OF REFERENCE SIGNS

1 Motor vehicle
2 Fuel cell stack
3 Fuel supply system
4 ECU (Controller)
11 Hydrogen supply path (Fuel supply path)
31 Hydrogen tank (Fuel tank)
32 Shutoff valve
33 Pressure sensor
35 Fuel supply valve

1. A fuel cell system comprising:
a fuel tank configured to store fuel gas;
a fuel cell stack configured to generate and supply power using the fuel gas from the fuel tank;
a fuel supply path interconnecting the fuel tank and the fuel cell stack;
a shutoff valve configured to allow supply of the fuel gas from the fuel tank by opening or closing the fuel supply path;
a fuel supply valve, situated downstream of the shutoff valve with respect to a supply direction of the fuel gas, configured to allow supply of the fuel gas to the fuel cell stack; and
a controller configured to control the shutoff valve and the fuel supply valve to control supply of the fuel gas from the fuel tank,
the controller causing the fuel supply valve to assume its closed state and the shutoff valve to assume its opened state during filling the fuel tank with the fuel gas.

2. The fuel cell system as claimed in claim 1, wherein the controller causes the shutoff valve to shift from its opened state to its closed state upon completion of filling the fuel tank with the fuel gas.

3. The fuel cell system as claimed in claim 1, wherein a pressure sensor is provided between the shutoff valve and the fuel supply valve; and
the controller causes the shutoff valve to assume its closed state when a pressure value detected by the pressure sensor exceeds an upper limit pressure.

4. The fuel cell system as claimed in claim 2, wherein
a pressure sensor is provided between the shutoff valve and the fuel supply valve; and
the controller causes the shutoff valve to assume its closed state when a pressure value detected by the pressure sensor exceeds an upper limit pressure.
